(19) United States
(12) Patent Application Publication
(10) Pub. No.: US 2023/0086617 A1
(43) Pub. Date: Mar. 23, 2023

(54) METHOD AND APPARATUS FOR PROCESSING DATA ASSOCIATED WITH A NEURAL NETWORK

(71) Applicant: Robert Bosch GmbH, Stuttgart (DE)

(72) Inventors: Alexandru Paul Condurache, Renningen (DE); Jens Eric Markus Mehnert, Malmsheim (DE); Paul Wimmer, Filderstadt - Bonlanden (DE)

(21) Appl. No.: 17/948,976

(22) Filed: Sep. 20, 2022

(30) Foreign Application Priority Data
Sep. 23, 2021 (DE) 10 2021 210 607.2

(51) Int. Cl. G06N 3/02

(52) U.S. Cl. CPC G06N 3/02

(57) ABSTRACT

A method, for example a computer-implemented method, for processing data associated with a, for example artificial, for example deep, neural network, for example, convolutional neural network (CNN). The method includes: representing at least one filter of the neural network based on at least one filter dictionary, and, optionally, processing input data, and/or data that can be derived or are derived from input data, by using the at least one filter.

### FIELD

The present invention relates to a method for processing data associated with a neural network.

The present invention furthermore relates to an apparatus for processing data associated with a neural network.

### SUMMARY

Exemplary embodiments of the present invention relate to a method, for example a computer-implemented method, for processing data associated with a, for example artificial, for example deep, neural network, for example convolutional neural network, CNN, comprising: representing at least one filter of the neural network based on at least one filter dictionary, and, optionally, processing input data, and/or data that can be derived or are derived from input data, by using the at least one filter. In further exemplary embodiments, the use of the at least one filter dictionary or of the filter that can be represented thereby may increase a quality of training or of processing of data by the neural network (inference) and may, for example, decrease a need for computing time resources and/or memory resources, for example for the training and/or the inference.

In further exemplary embodiments of the present invention, it is provided that the at least one filter dictionary at least partially characterizes, for example spans, a linear space, wherein the at least one filter dictionary may, for example, be characterized by [symbol] :={g⁽¹⁾, . . . , g^{(N)}}⊂ [symbol] ^{K1×K2}, wherein g⁽ⁱ⁾ characterizes an i-th element of the at least one filter dictionary, for example an i-th filter, for example filter kernel, where i=1, . . . , N, wherein K1 characterizes a size of the filters of the at least one filter dictionary (FD) in a first dimension, wherein K2 characterizes a size of the filters of the at least one filter dictionary in a second dimension, wherein, for example, K1=K2=K applies, wherein span{ [symbol] } characterizes the linear space that the at least one filter dictionary at least partially characterizes.

In further exemplary embodiments of the present invention, at least one filter or filter kernel may also have more than two dimensions, for example three or more, or one dimension, wherein the principle according to the embodiments is also applicable to such configurations, without limiting generality.

In further exemplary embodiments of the present invention, at least one filter or filter kernel may be square, for example, where K1=K2, wherein K1< >K2 is also possible in further exemplary embodiments.

In further exemplary embodiments of the present invention, more than one filter dictionary may also be provided. For example, in the case of a plurality of filter dictionaries, at least a first filter dictionary with filters of a first size (e.g., K1×K2) may be provided, and at least a second filter dictionary with filters of a second size (e.g., K1′×K2′, wherein K1′=K2′ is also possible in further exemplary embodiments) may be provided.

In further exemplary embodiments of the present invention, it is provided that a) the at least one filter dictionary does not completely span a space, for example [symbol] ^{K1×K2}, for example is undercomplete, or that b) at least some elements of the at least one filter dictionary are linearly dependent on one another, wherein the at least one filter dictionary is, for example, overcomplete.

In further exemplary embodiments of the present invention, it is provided that the at least one filter dictionary is different from a standard basis [symbol] , for example according to [symbol] :={e⁽ⁿ⁾: n=1, . . . , K²}, wherein e⁽ⁿ⁾ characterizes an n-th unit vector associated with the standard basis [symbol] . In further exemplary embodiments, further degrees of freedom for representing at least one filter, for example in the form of a linear combination of a plurality of elements of the filter dictionary, are thus given, for example.

In further exemplary embodiments of the present invention, it is provided that the representing of the at least one filter of the neural network based on the at least one filter dictionary can be characterized by the following equation and/or is performed based on the following equation: h=Σₙ₌₁^{N}λₙ·g⁽ⁿ⁾, wherein h characterizes the at least one filter, wherein g⁽ⁿ⁾ characterizes an n-th element, for example an n-th filter, of the at least one filter dictionary, wherein λₙ characterizes a coefficient associated with the n-th element, for example n-th filter, of the at least one filter dictionary, and wherein n is an index variable that characterizes one of the N elements, for example one of the N filters, of the at least one filter dictionary.

In further exemplary embodiments of the present invention, representing a plurality of filters h^{(α,β)}, associated with, for example, a layer of the neural network, based on the at least one filter dictionary can be characterized by the following equation and/or is performed based on the following equation: h^{(α,β)}=Σₙ₌₁^{N}λₙ^{(α,β)}·g⁽ⁿ⁾, wherein α characterizes an index variable associated with a number of output channels of the layer, wherein β characterizes an index variable associated with a number of input channels of the layer, wherein λₙ^{(α,β)} characterizes a coefficient, associated with the n-th element, for example n-th filter, of the at least one filter dictionary, for the output channel α and the input channel β of the layer.

In further exemplary embodiments of the present invention, it is provided that the processing of the input data, and/or of the data that can be derived or are derived from the input data (e.g., data that are output by an inner layer (“hidden layer”) of the neural network), by using the at least one filter can be characterized by the following equation and/or is performed based on the following equation:

$$h ★ X = {( {\sum }_{β = 1}^{{c}_{in}} {\sum }_{n = 1}^{N} {λ}_{n}^{( α , β )} \cdot ( {g}^{( n )} ★ {X}^{( β )} ) )}_{α} ,$$

wherein X characterizes the input data, or the data that can be derived or are derived from the input data, for example an input feature map for one or the layer of the neural network, wherein α characterizes an index variable associated with a number of output channels of the layer, wherein β characterizes an index variable associated with a number of input channels of the layer, wherein λₙ^{(α,β)} characterizes a coefficient, associated with the n-th element, for example n-th filter, of the at least one filter dictionary, for the output channel α and the input channel β of the layer, wherein cᵢₙ characterizes a number of the input channels of the layer, wherein * characterizes a convolution operation.

In further exemplary embodiments of the present invention, it is provided that the method comprises: initializing the at least one filter dictionary, for example prior to representing the at least one filter and/or processing input data, for example, wherein initializing, for example, comprises at least one of the following elements: a) random-based initializing, for example by assigning random numbers or pseudorandom numbers to at least some filter coefficients g_{i,j}⁽ⁿ⁾ of at least some elements or filters of the at least one filter dictionary (for example, an n-th filter or filter kernel of the at least one filter dictionary has, e.g., 3×3 filter coefficients: g_{1,1}⁽ⁿ⁾, g_{1,2}⁽ⁿ⁾, g_{1,3}⁽ⁿ⁾, g_{2,1}⁽ⁿ⁾, . . . , g_{3,3}⁽ⁿ⁾), b) random-based initializing such that a or the linear space span{ [symbol] } that can be characterized by the at least one filter dictionary characterizes a orthonormal basis, for example comprising b1) initializing at least some, for example all, filter coefficients g_{i,j}⁽ⁿ⁾—of at least some, for example all, elements or filters of the at least one filter dictionary with filter coefficient values, for example independently equally distributed filter coefficient values, b2) applying the Gram-Schmidt orthogonalization method to the elements or filters of the at least one filter dictionary, c) random-based initializing by means of c1) initializing at least some, for example all, filter coefficients g_{i,j}⁽ⁿ⁾ of at least some, for example all, elements or filters of the at least one filter dictionary with filter coefficient values, for example independently equally distributed filter coefficient values, c2) scaling, or rescaling, the at least one filter dictionary based on at least one statistical quantity, for example a mean and/or a standard deviation.

In further exemplary embodiments of the present invention, it is provided that the method comprises: initializing coefficients of, for example, some, for example all, elements or filters of the at least one filter dictionary, comprising at least one of the following aspects: a) random-based or pseudorandom-based initializing of the coefficients, b) initializing the coefficients based on the at least one filter dictionary.

In further exemplary embodiments of the present invention, it is provided that the method comprises: reducing, for example thinning out, for example pruning, at least one component of the at least one filter dictionary, wherein reducing comprises at least one of the following elements: a) reducing at least one element, for example filter, of the at least one filter dictionary, for example by zeroing at least one filter coefficient, for example a plurality of filter coefficients, of the at least one element, for example filter, of the at least one filter dictionary, b) removing or deleting at least one element, for example filter, of the at least one filter dictionary, c) removing or deleting at least one coefficient associated with the at least one filter dictionary.

In further exemplary embodiments of the present invention, it is provided that the method comprises at least one of the following elements: a) performing the reducing after an or the initializing of the at least one filter dictionary, b) performing the reducing after an or the initializing of coefficients or of the coefficients of, for example, some, for example all, elements or filters of the at least one filter dictionary, c) performing the reducing during a training of the neural network, d) performing the reducing after a or the training of the neural network.

In further exemplary embodiments of the present invention, the reducing may occur, e.g., in an event-driven manner, for example based on an occurrence of particular data values, e.g. of the output data that can be determined by means of the neural network, and/or in a time-controlled manner, for example repeatedly, for example periodically. Combinations thereof are also possible in further exemplary embodiments.

In further exemplary embodiments of the present invention, it is provided that the method comprises at least one of the following elements: a) using the at least one, for example the same, filter dictionary for a plurality of layers, for example all layers, of the neural network, b) using the at least one, for example the same, filter dictionary for a plurality, for example all, layers of the neural network that are associated with the same spatial size of data to be processed, for example feature maps, c) using the at least one, for example the same, filter dictionary for a respective residual block, for example in the case of a residual neural network, for example ResNet, d) using the at least one, for example the same, filter dictionary for a layer of the neural network.

In further exemplary embodiments of the present invention, the neural network may also comprise, in addition to one or more layers which respectively perform filtering by using the at least one filter dictionary or by using filters that can be represented by means of the at least one filter dictionary (i.e., layers which, for example, perform two-dimensional convolution operations of corresponding input data for the respective layer, e.g., input feature map, with the respective filter mask), one or more further components, such as other functional layers, for example pooling layers, such as max-pooling layers, fully connected layers, for example in terms of a multi-layer perceptron (MLP), at least one, for example non-linear, activation function, etc.

In further exemplary embodiments of the present invention, it is provided that the method comprises: training the neural network, for example based on training data, wherein a trained neural network is, for example, obtained, and, optionally, using the, for example trained, neural network, for example for processing the input data.

Further exemplary embodiments of the present invention relate to a method, for example a computer-implemented method, for training a, for example artificial, for example deep, neural network, for example convolutional neural network, CNN, wherein at least one filter of the neural network can be represented and/or is represented based on at least one filter dictionary, wherein the method comprises: training at least one component of the at least one filter dictionary, wherein the training of the at least one component of the at least one filter dictionary is, for example, performed at least temporarily simultaneously and/or together with a training of at least one other component of the neural network.

In further exemplary embodiments of the present invention, it is provided that the training comprises a training of one, for example only one or at least one, element of the at least one filter dictionary.

In further exemplary embodiments of the present invention, it is provided that the method comprises: providing a filter dictionary characterizing a standard basis, wherein the standard basis can, for example, be characterized according to [symbol] :={e⁽ⁿ⁾: n=1, . . . , K²}, wherein e(n) characterizes an n-th unit vector associated with the standard basis [symbol] , changing the filter dictionary, characterizing the standard basis, based on the training. Thus, in further exemplary embodiments, flexibility with regard to the representation of filters for the neural network is increased in comparison to using the standard basis.

In further exemplary embodiments of the present invention, it is provided that the method comprises: providing a filter dictionary not characterizing a standard basis, changing the filter dictionary, not characterizing a standard basis, based on the training.

In further exemplary embodiments of the present invention, it is provided that the method comprises: providing a pre-trained neural network or performing a first training, for example pre-training, for the neural network, optionally performing a reducing, for example the reducing according to exemplary embodiments, on the pre-trained neural network and, optionally, performing a further training.

In further exemplary embodiments of the present invention, it is provided that the training comprises: training the at least one filter dictionary together with at least one coefficient associated with the at least one filter dictionary.

In further exemplary embodiments of the present invention, it is provided that the processing of the input data comprises at least one of the following elements: a) processing multi-dimensional data, b) processing image data, c) processing audio data, for example voice data and/or operating noises from technical equipment systems, such as machines, d) processing video data or parts of video data, e) processing sensor data, wherein the processing of the input data comprises, for example, an analysis, for example a classification, of the input data.

In further exemplary embodiments of the present invention, it is provided that the method comprises: using output data obtained based on the processing of the input data to influence, for example control and/or regulate, at least one component of a technical system, for example cyber-physical system.

In further exemplary embodiments of the present invention, it is provided that the method comprises at least one of the following elements: a) initializing the at least one filter dictionary, b) initializing coefficients associated with the at least one filter dictionary, c) reducing, for example thinning out, for example pruning, at least one component of the at least one filter dictionary, d) training the neural network, for example the at least one filter dictionary, for example together with at least one further component of the neural network, for example based on a gradient-based optimization method, for example a stochastic gradient-based optimization method.

Further exemplary embodiments of the present invention relate to an apparatus for performing the method according to the embodiments.

Further exemplary embodiments of the present invention relate to a computer-readable storage medium comprising instructions that, when executed by a computer, cause the computer to perform the method according to the embodiments.

Further exemplary embodiments of the present invention relate to a computer program comprising instructions that, when the program is executed by a computer, cause the computer to perform the method according to the embodiments.

Further exemplary embodiments of the present invention relate to a data carrier signal that transmits and/or characterizes the computer program according to the embodiments.

Further exemplary embodiments of the present invention relate to a use of the method according to the embodiments and/or of the apparatus according to the embodiments and/or of the computer-readable storage medium according to the embodiments and/or of the computer program according to the embodiments and/or of the data carrier signal according to the embodiments for at least one of the following elements: a) representing at least one filter of the neural network based on the at least one filter dictionary, b) processing input data, and/or data that can be derived or are derived from input data, by using the at least one filter, c) increasing flexibility with regard to the representation of the at least one filter, d) adapting dynamically, i.e., adapting can be performed, for example, during a performance of the method, the at least one filter, for example during a training in which at least one further component of the neural network is also trained, e) decreasing a complexity of the neural network, f) improving a generalization by the neural network, for example in the sense that a behavior of the neural network during a training becomes more similar to a behavior of the neural network outside of the training, for example when evaluating input data other than training data, g) reducing or decreasing an overfitting, for example “memorizing” the training data, h) saving storage resources and/or computing time resources required for a representation and/or an evaluation of the neural network, i) decreasing a training duration, j) enabling use of existing reduction methods or pruning methods for neural networks, for example structured and/or unstructured pruning methods, for example also for reducing at least one component of the at least one filter dictionary, k) increasing flexibility with regard to initializing the at least one filter dictionary, l) enabling flexible use of the at least one filter dictionary, for example selectively, for at least one component, for example a layer, of the neural network, for example a flexible sharing of the at least one filter dictionary between different components of the neural network, m) increasing a quality of a training and/or an evaluation, for example inference, of the neural network.

Further features, possible applications and advantages of the present invention emerge from the description below of exemplary embodiments of the present invention, which are illustrated in the figures. All described or depicted features by themselves or in any combination constitute the subject matter of the present invention, regardless of their formulation or representation in the description or in the figures.

### BRIEF DESCRIPTION OF THE DRAWINGS

FIG. 1 schematically illustrates a simplified flowchart according to exemplary embodiments of the present invention.

FIG. 2 schematically illustrates a simplified block diagram according to exemplary embodiments of the present invention.

FIG. 3 schematically illustrates a simplified flow chart according to further exemplary embodiments of the present invention.

FIG. 4 schematically illustrates a simplified flow chart according to further exemplary embodiments of the present invention.

FIG. 5 schematically illustrates a simplified flow chart according to further exemplary embodiments of the present invention.

FIG. 6 schematically illustrates a simplified block diagram according to further exemplary embodiments of the present invention.

FIG. 7 schematically illustrates a simplified block diagram according to further exemplary embodiments of the present invention.

FIG. 8 schematically illustrates a simplified flow chart according to further exemplary embodiments of the present invention.

FIG. 9 schematically illustrates a simplified flow chart according to further exemplary embodiments of the present invention.

FIG. 10 schematically illustrates a simplified flow chart according to further exemplary embodiments of the present invention.

FIG. 11 schematically illustrates a simplified flow chart according to further exemplary embodiments of the present invention.

FIG. 12 schematically illustrates a simplified flow chart according to further exemplary embodiments of the present invention.

FIG. 13 schematically illustrates a simplified block diagram according to further exemplary embodiments of the present invention.

FIG. 14 schematically illustrates a simplified flow chart according to further exemplary embodiments of the present invention.

FIG. 15 schematically illustrates a simplified block diagram according to further exemplary embodiments of the present invention.

FIG. 16 schematically illustrates aspects of uses according to further exemplary embodiments of the present invention.

### DETAILED DESCRIPTION OF EXAMPLE EMBODIMENTS

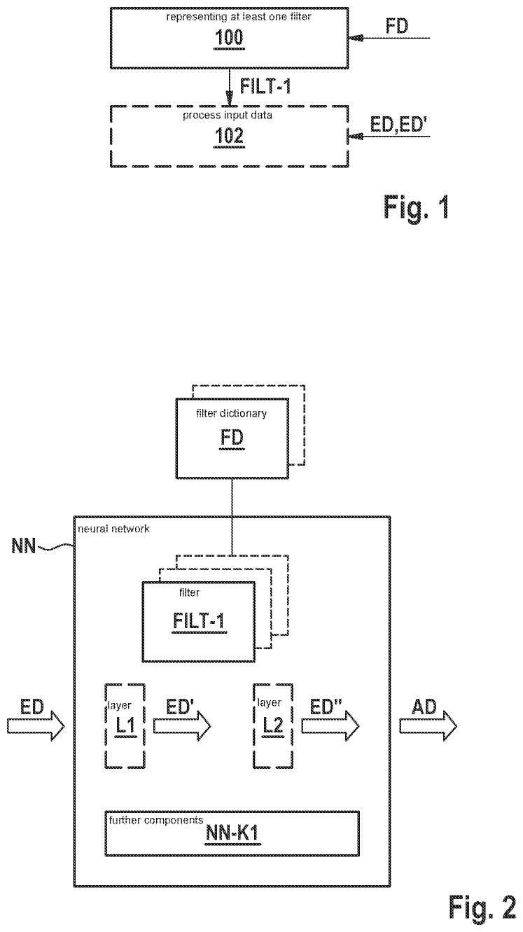

Exemplary embodiments of the present invention, cf. FIGS. 1, 2, relate to a method, for example a computer-implemented method, for processing data associated with a, for example artificial, for example deep, neural network NN (FIG. 2), for example convolutional neural network, CNN, comprising: representing 100 (FIG. 1) at least one filter FILT-1 of the neural network NN based on at least one filter dictionary FD, and, optionally, processing 102 input data ED, and/or data ED′ that can be derived or are derived from input data ED, by using the at least one filter FILT-1.

In further exemplary embodiments, the use of the at least one filter dictionary FD or of the filter FILT-1 that can be represented thereby may increase a quality of training or of processing of data by the neural network (inference) and may, for example, reduce a need for computing time resources and/or memory resources, for example for the training and/or the inference.

In further exemplary embodiments, it is provided that the at least one filter dictionary FD at least partially characterizes a linear space, wherein, for example, the at least one filter dictionary FD can be characterized by [symbol] :={g⁽¹⁾, . . . , g^{(N)}}⊂ [symbol] ^{K1×K2} wherein g⁽ⁱ⁾ characterizes an i-th element of the at least one filter dictionary FD, for example an i-th filter, for example filter kernel, where i=1, . . . , N, wherein K1 characterizes a size of the filters of the at least one filter dictionary FD in a first dimension, wherein K2 characterizes a size of the filters of the at least one filter dictionary FD in a second dimension, wherein, for example, K1=K2=K applies, wherein [symbol] characterizes the linear space that the at least one filter dictionary FD at least partially characterizes.

In further exemplary embodiments, at least one filter or filter kernel may also have more than two dimensions, for example three or more, wherein the principle according to the embodiments is also applicable to such configurations, without limiting generality.

In further exemplary embodiments, at least one filter or filter kernel may be square, for example, where K1=K2, wherein K1< >K2 is also possible in further exemplary embodiments.

In further exemplary embodiments, more than one filter dictionary FD may also be provided. For example, in the case of a plurality of filter dictionaries, at least a first filter dictionary with filters of a first size (e.g., K1×K2) may be provided, and at least a second filter dictionary with filters of a second size (e.g., K1′×K2′, wherein K1′=K2′ is also possible in further exemplary embodiments) may be provided.

In further exemplary embodiments, it is provided that a) the at least one filter dictionary FD does not completely span a space, for example [symbol] ^{K1×K2}, for example is undercomplete, or that b) at least some elements of the at least one filter dictionary FD are linearly dependent on one another, wherein the at least one filter dictionary FD is, for example, overcomplete.

In further exemplary embodiments, it is provided that the at least one filter dictionary FD, which can, for example, be characterized according to [symbol] :={g⁽¹⁾, . . . , g^{(N)}}⊂ [symbol] ^{K1×K2} or [symbol] :={g⁽¹⁾, . . . , g^{(N)}}⊂ [symbol] ^{K×K}, is different from a standard basis [symbol] , for example according to [symbol] :={e⁽ⁿ⁾: n=1, . . . , K²}, wherein e⁽ⁿ⁾ characterizes an n-th unit vector associated with the standard basis [symbol] . In further exemplary embodiments, further degrees of freedom for representing 100 at least one filter, for example in the form of a linear combination of a plurality of elements of the filter dictionary FD, are thus given, for example.

In further exemplary embodiments, it is provided that the representing 100 (FIG. 1) of the at least one filter FILT-1 of the neural network NN based on the at least one filter dictionary FD can be characterized by the following equation and/or is performed based on the following equation: h=Σₙ₌₁^{N}λₙ·g⁽ⁿ⁾, wherein h characterizes the at least one filter FILT-1, wherein g⁽ⁿ⁾ characterizes an n-th element, for example an n-th filter, of the at least one filter dictionary FD, wherein λₙ characterizes a coefficient associated with the n-th element, for example n-th filter, of the at least one filter dictionary FD, and wherein n is an index variable that characterizes one of the N elements, for example one of the N filters, of the at least one filter dictionary FD.

In further exemplary embodiments, representing 100 a plurality of filters h^{(α,β)}, associated with, for example, a layer L1 of the neural network NN, based on the at least one filter dictionary FD can be characterized by the following equation and/or is performed based on the following equation: h^{(α,β)}=Σₙ₌₁^{N}λₙ^{(α,β)}·g⁽ⁿ⁾, wherein a characterizes an index variable associated with a number of output channels of the layer L1, wherein β characterizes an index variable associated with a number of input channels of the layer L1, wherein λₙ^{(α,β)} characterizes a coefficient, associated with the n-th element, for example n-th filter, of the at least one filter dictionary FD, for the output channel α and the input channel β of the layer L1.

In further exemplary embodiments, it is provided that the processing of the input data ED, and/or of the data ED′, ED′ that can be derived or are derived from the input data ED (e.g., data that are output by an inner layer (“hidden layer”) L2 of the neural network NN), by using the at least one filter FILT-1 can be characterized by the following equation and/or is performed based on the following equation:

$$h ★ X = {( {\sum }_{β = 1}^{{c}_{in}} {\sum }_{n = 1}^{N} {λ}_{n}^{( α , β )} \cdot ( {g}^{( n )} ★ {X}^{( β )} ) )}_{α} ,$$

wherein X characterizes the input data, or the data that can be derived or are derived from the input data, for example an input feature map for one or the layer L1, L2 of the neural network NN, wherein a characterizes an index variable associated with a number of output channels of the layer L1, wherein β characterizes an index variable associated with a number of input channels of the layer L1, wherein λₙ^{(α,β)} characterizes a coefficient, associated with the n-th element, for example n-th filter, of the at least one filter dictionary FD, for the output channel α and the input channel β of the layer L1, wherein cᵢₙ characterizes a number of the input channels of the layer L1, wherein * characterizes a convolution operation.

In further exemplary embodiments, FIG. 2, the neural network NN may also comprise, in addition to one or more layers L1, L2 which respectively perform filtering by using the at least one filter dictionary FD or by using filters that can be represented by means of the at least one filter dictionary FD (i.e., layers L1, L2 which, for example, perform two-dimensional convolution operations of corresponding input data ED, ED′ for the respective layer L1, L2, e.g., input feature map, with the respective filter mask (which can be characterized based on the filter dictionary FD), one or more further components NN-K1, such as other functional layers, for example pooling layers, such as max-pooling layers, fully connected layers, for example in terms of a multi-layer perceptron (MLP), etc. For the sake of clarity, these optional further components NN-K1 are collectively designated with the block NN-K1 in the schematic representation of FIG. 2 and not as individual components with a topological relation to the layers L1, L2 (e.g., arrangement of a max-pooling layer between the two layers L1, L2 provided for filtering). By using the layers L1, L2 and, where applicable, the optional further components NN-K1, the neural network NN in further exemplary embodiments may, for example, receive input data ED, for example from a data source not shown, and, based on the input data ED, form output data AD (inference), and output the output data AD to a data sink not shown, for example.

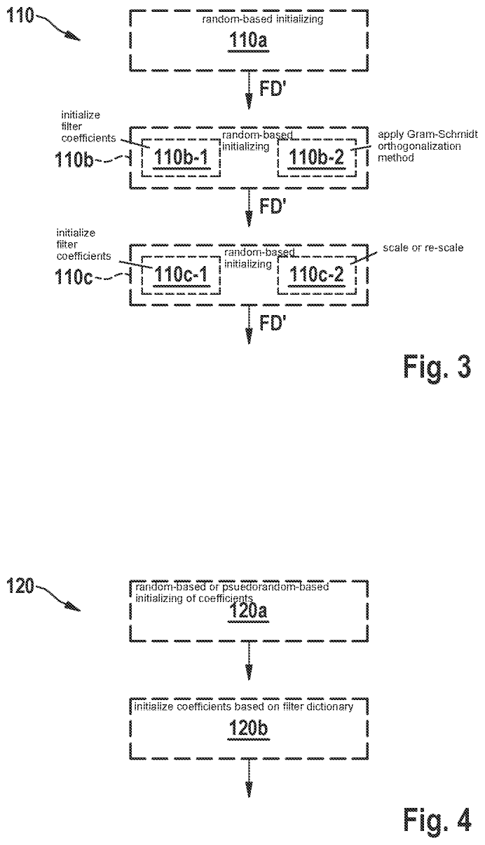

In further exemplary embodiments, FIG. 3, it is provided that the method comprises: initializing 110 the at least one filter dictionary FD (FIG. 2), for example prior to representing 100 (FIG. 1) the at least one filter FILT-1 and/or optionally processing 102 input data ED, for example, wherein initializing 110, for example, comprises at least one of the following elements: a) random-based initializing 110a, for example by assigning random numbers or pseudorandom numbers to at least some filter coefficients g_{i,j}⁽ⁿ⁾ of at least some elements or filters of the at least one filter dictionary FD (for example, an n-th filter or filter kernel of the at least one filter dictionary FD has, e.g., 3×3 filter coefficients: g_{1,1}⁽ⁿ⁾, g_{1,2}⁽ⁿ⁾, g_{1,3}⁽ⁿ⁾, g_{2,1}⁽ⁿ⁾, . . . , g_{3,3}⁽ⁿ⁾), which can, for example, be initialized in a random-based and/or pseudorandom-based manner, b) random-based initializing 110b such that a or the linear space span{ [symbol] } is spanned by an orthonormal basis [symbol] , for example comprising b1) initializing 110b-1 at least some, for example all, filter coefficients g_{i,j}⁽ⁿ⁾ of at least some, for example all, elements or filters of the at least one filter dictionary FD with filter coefficient values, for example independently equally distributed filter coefficient values, b2) applying 110b-2 the Gram-Schmidt orthogonalization method to the elements or filters of the at least one filter dictionary, c) random-based initializing 110c by means of c1) initializing 110c-1 at least some, for example all, filter coefficients g_{i,j}⁽ⁿ⁾ of at least some, for example all, elements or filters of the at least one filter dictionary FD with filter coefficient values, for example independently equally distributed filter coefficient values, c2) scaling 110c, or rescaling, the at least one filter dictionary FD based on at least one statistical quantity, for example a mean and/or a standard deviation.

Initializing 110, 110a, 110b, 110c results in at least one initialized filter dictionary FD′ which can be used for representing 100 according to FIG. 1.

In further exemplary embodiments, the random-based initializing 110b such that a or the linear space span{ [symbol] } that can be characterized by the at least one filter dictionary is spanned by an orthonormal basis, may, for example, comprise at least one of the aspects mentioned by way of example below:

1) Initializing at least some, for example all, filter coefficients g⁽¹⁾, . . . , g^{(K}^{²}⁾∈ [symbol] ^{K×K} with independently equally distributed g_{i,j}⁽ⁿ⁾˜N(0,1), for example for all n=1, . . . , K², i, k=1, . . . , K,
2) Applying the Gram-Schmidt orthogonalization method to the basis {g⁽¹⁾, . . . , q^{(K}^{²}⁾} in order to obtain an orthonormal basis [symbol] ={\tilde{g}⁽¹⁾, . . . , \tilde{g}^{(K}^{²}⁾} that characterizes the at least one filter dictionary, for example.
3) Optionally, for an initialization of the coefficients λ, μₕ←0 (average of the spatial (filter) coefficients,
4)

$${σ}_{h} ← \sqrt{\frac{2}{{c}_{in} \cdot {K}^{2}}}$$

Variance of the spatial coefficients, for example according to a Kaiming normal initialization, wherein cᵢₙ characterizes a number of input channels. In further exemplary embodiments, other values for the mean or the variance may also be selected.
5) Initializing the spatial coordinates φₙ^{(α,β)}˜ [symbol] (μₕ,σₕ²) in a manner independently equally distributed for all α∈{1, . . . , cₒᵤₜ}, β∈{1, . . . , cᵢₙ}, n∈{1, . . . , K²},
6) Calculating a basis transformation matrix W, for example according to

$$Ψ = {( 〈 {g}^{( m )} , {e}^{( n )} 〉 )}_{n , m} ∈ {ℝ}^{{K}^{2} \times N} ,$$

7) Determining the coefficients λ^{(α,β)}←ψ^{T}·φ^{(α,β)} with respect to the at least one filter dictionary,
8) Providing the initialized filter dictionary [symbol] ={g⁽¹⁾, . . . , g^{(N)}} and associated coefficients λ=(λn^{(α,β)})_{α,β,n}.

In further exemplary embodiments, the random-based initializing 110c by means of c1) initializing 110c-1 at least some, for example all, filter coefficients g_{i,j}⁽ⁿ⁾ of at least some, for example all, elements or filters of the at least one filter dictionary with filter coefficient values, for example independently equally distributed filter coefficient values, c2) scaling 110c-2, or rescaling, the at least one filter dictionary based on at least one statistical quantity, for example a mean and/or a standard deviation, may, for example, comprise at least one of the aspects mentioned by way of example below:

10) Initializing at least some, for example all, filter coefficients g⁽¹⁾, . . . , g^{(N)}∈ [symbol] ^{K×K} with independently equally distributed g_{i,j}⁽ⁿ⁾˜ [symbol] (0,1),
11) For example, for each spatial component i, j of the elements of the at least one element, for example filter, of the at least one filter dictionary, a sample mean μ_{i,j} or a sample variance σ_{i,j}, is, for example, determined over the entire filter dictionary, e.g., according to

$${μ}_{i , j} := \frac{1}{N} {\sum }_{n = 1}^{N} {g}_{i , j}^{( n )} and {σ}_{i , j}^{2} := \frac{1}{N} {\sum }_{n = 1}^{N} {( {g}_{i , j}^{( n )} - {μ}_{i , j} )}^{2} .$$

12) Scaling, or rescaling, the filter dictionary, for example according to

$${\tilde{g}}_{i , j}^{( n )} ← \sqrt{\frac{1}{N} - \frac{1}{{N}^{2}}} \cdot \frac{{g}_{i , j}^{( n )} - {μ}_{i , j}}{{σ}_{i , j}} + \frac{1}{N} ,$$

13) Optionally, for an initialization of the coefficients λ, μₕ←0 (average of the spatial (filter) coefficients,
14)

$${σ}_{h} ← \sqrt{\frac{2}{{c}_{in} \cdot {K}^{2}}}$$

Variance of the spatial coefficients, for example according to a Kaiming normal initialization, wherein cᵢₙ characterizes a number of input channels. In further exemplary embodiments, other values for the mean or the variance may also be selected.
15) Initializing the coordinates according to λₙ^{(α,β)}˜ [symbol] (μₕ,σₕ²), in a manner independently equally distributed for all α∈{1, . . . , cₒᵤₜ}, β∈{1, . . . , cᵢₙ}, n∈{1, . . . , N}
16) Providing the initialized filter dictionary [symbol] ={\tilde{g}⁽¹⁾, . . . , \tilde{g}^{(N)}} and associated coefficients λ=(λₙ^{(α,β)})_{α,β,n}.

In further exemplary embodiments, FIG. 4, it is provided that the method comprises: Initializing 120 coefficients of, for example, some, for example all, elements or filters of the at least one filter dictionary FD, comprising at least one of the following aspects: a) random-based or pseudorandom-based initializing 120a of the coefficients, b) initializing 120b the coefficients based on the at least one filter dictionary FD or initialized filter dictionary FD′, see above, for example aspects 3) to 8) or 13) to 16).

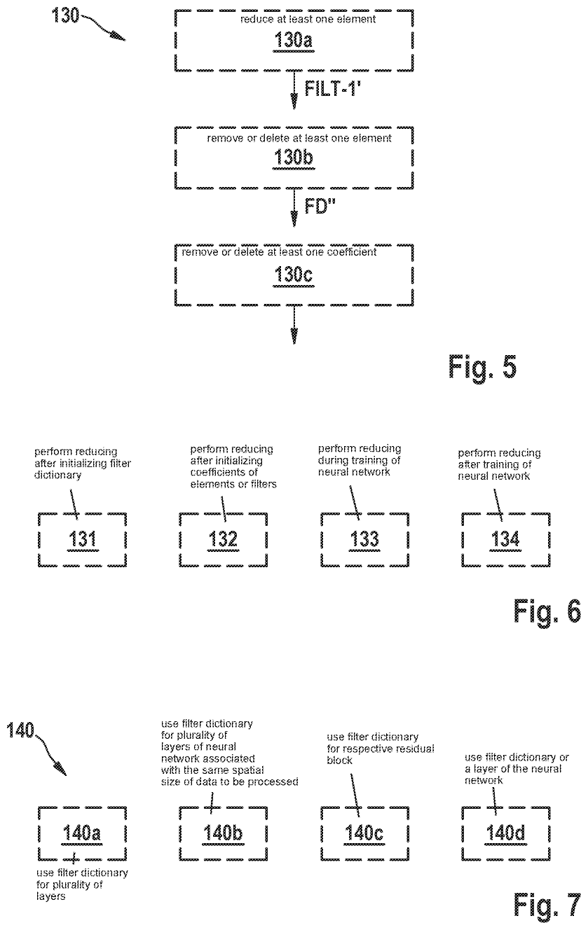

In further exemplary embodiments, FIG. 5, it is provided that the method comprises: reducing 130, for example thinning out, for example pruning, at least one component of the at least one filter dictionary FD, wherein reducing 130 comprises at least one of the following elements: a) reducing 130a at least one element, for example filter, of the at least one filter dictionary FD, for example by zeroing at least one filter coefficient, for example a plurality of filter coefficients, of the at least one element, for example filter, of the at least one filter dictionary FD, whereby a reduced filter FILT-1′ or a reduced filter dictionary is, for example, obtained, b) removing 130b or deleting at least one element, for example filter, of the at least one filter dictionary FD, whereby a reduced filter dictionary FD″ is, for example, obtained, c) removing 130c or deleting at least one coefficient associated with the at least one filter dictionary FD, whereby a reduced filter can, for example, be obtained.

In further exemplary embodiments, FIG. 6, it is provided that the method comprises at least one of the following elements: a) performing 131 the reducing 130 after an or the initializing of the at least one filter dictionary FD, b) performing 132 (FIG. 6) the reducing 130 after a or the initializing of coefficients or of the coefficients of, for example, some, for example all, elements or filters of the at least one filter dictionary FD, c) performing 133 the reducing 130 during a training of the neural network NN, d) performing 134 the reducing 130 after a or the training of the neural network NN.

In further exemplary embodiments, the reducing 130 may occur, e.g., in an event-driven manner, for example based on an occurrence of particular data values, e.g. of the output data AD that can be determined by means of the neural network, and/or in a time-controlled manner, for example repeatedly, for example periodically. Combinations thereof are also possible in further exemplary embodiments.

In further exemplary embodiments, FIG. 7, it is provided that the method comprises at least one of the following elements: a) using 140a the at least one, for example the same, filter dictionary FD for a plurality of layers L1, L2, for example all layers, of the neural network NN, b) using 140b the at least one, for example the same, filter dictionary FD for a plurality, for example all, layers of the neural network NN that are associated with the same spatial size of data to be processed, for example feature maps, c) using 140c the at least one, for example the same, filter dictionary FD for a respective residual block, for example in the case of a residual neural network, for example ResNet, d) using 140d the at least one, for example the same, filter dictionary FD for a layer L1 of the neural network NN.

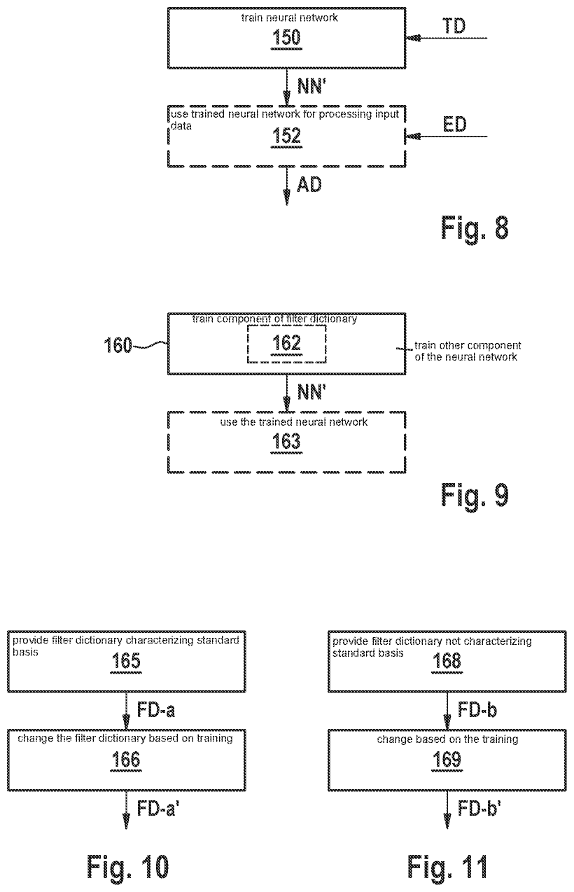

In further exemplary embodiments, FIG. 8, it is provided that the method comprises: training 150 the neural network NN, for example based on training data TD, wherein a trained neural network NN′ is, for example, obtained, and, optionally, using 152 the, for example trained, neural network NN′, for example for processing the input data ED.

Further exemplary embodiments, FIG. 9, relate to a method, for example a computer-implemented method, for training a, for example artificial, for example deep, neural network NN, for example convolutional neural network, CNN, wherein at least one filter FILT-1 of the neural network NN can be represented and/or is represented based on at least one filter dictionary FD, wherein the method comprises: training 160 at least one component of the at least one filter dictionary FD, wherein the training 160 of the at least one component of the at least one filter dictionary FD is, for example, performed at least temporarily simultaneously and/or together with a training 162 of at least one other component NN-K1 of the neural network NN.

In further exemplary embodiments, the training may also comprise, for example only, a training of the at least one filter dictionary, for example without training coefficients associated with the at least one filter dictionary in the process.

The optional block 163 symbolizes a use of the trained neural network.

In further exemplary embodiments, FIG. 10, it is provided that the method comprises: providing 165 a filter dictionary FD-a characterizing a standard basis, wherein the standard basis can, for example, be characterized according to [symbol] :={e⁽ⁿ⁾: n=1, . . . , K²}, wherein e(n) characterizes an n-th unit vector associated with the standard basis [symbol] , changing 166 the filter dictionary FD-a, characterizing the standard basis, based on the training 150, 160, whereby a changed or trained filter dictionary FD-a′ can, for example, be obtained. Thus, in further exemplary embodiments, flexibility with regard to the representation of filters for the neural network NN is increased in comparison to using the standard basis.

In further exemplary embodiments, FIG. 11, it is provided that the method comprises: providing 168 a filter dictionary FD-b not characterizing a standard basis, changing 169 the filter dictionary FD-b, not characterizing a standard basis, based on the training 150, 160, whereby a changed or trained filter dictionary FD-b′ can, for example, be obtained.

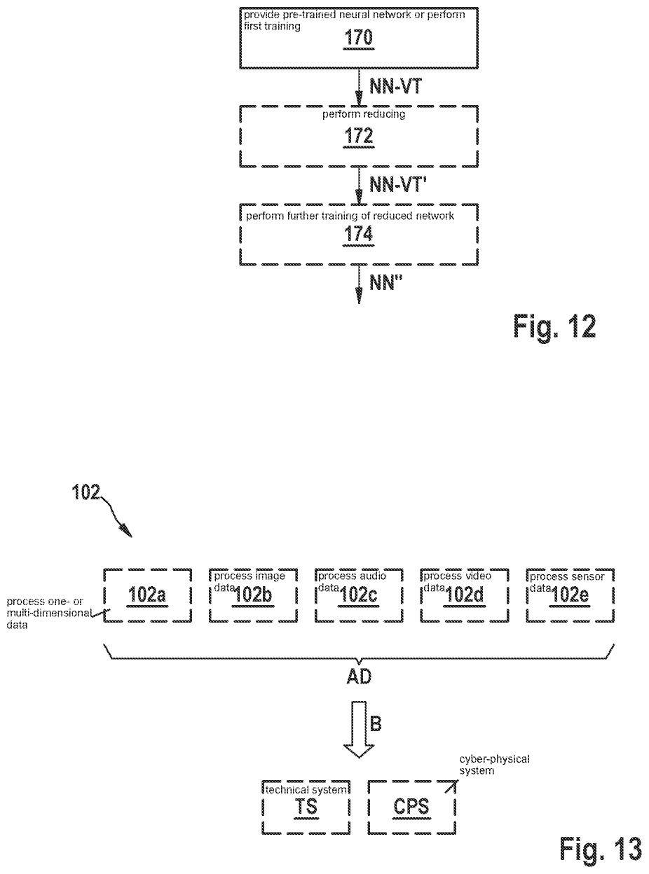

In further exemplary embodiments, FIG. 12, it is provided that the method comprises: providing 170 a pre-trained neural network NN-VT or performing a first training, for example pre-training, for the neural network, optionally performing 172 a reducing, for example the reducing 130 according to exemplary embodiments, on the pre-trained neural network NN, whereby the pre-trained neural network NN-VT′ can be obtained, and, optionally, performing 174 a further training of the reduced network NN-VT′, which results in a further trained network NN″.

In further exemplary embodiments, it is provided that the training 150, 160 comprises: training the at least one filter dictionary FD together with at least one coefficient associated with the at least one filter dictionary FD.

In further exemplary embodiments, the training 150, 160 may also comprise, for example only, a training of the at least one filter dictionary, for example without training coefficients associated with the at least one filter dictionary in the process.

In further exemplary embodiments, the training 150, 160 may also comprise, for example only, a training of at least one coefficient associated with the at least one filter dictionary.

In further exemplary embodiments, FIG. 13, it is provided that the processing 102 (see also FIG. 1) of the input data ED comprises at least one of the following elements: a) processing 102a one- and/or multi-dimensional data, b) processing 102b image data (which generally can represent multi-dimensional data), c) processing 102c audio data, for example voice data and/or operating noises from technical equipment or systems, such as machines, d) processing 102d video data or parts of video data, e) processing 102e sensor data, wherein the processing 102 of the input data ED comprises, for example, an analysis, for example a classification, of the input data ED.

In further exemplary embodiments, FIG. 13, it is provided that the method comprises: using output data AD obtained based on the processing 102 of the input data ED to influence B, for example control and/or regulate, at least one component of a technical system TS, for example cyber-physical system CPS.

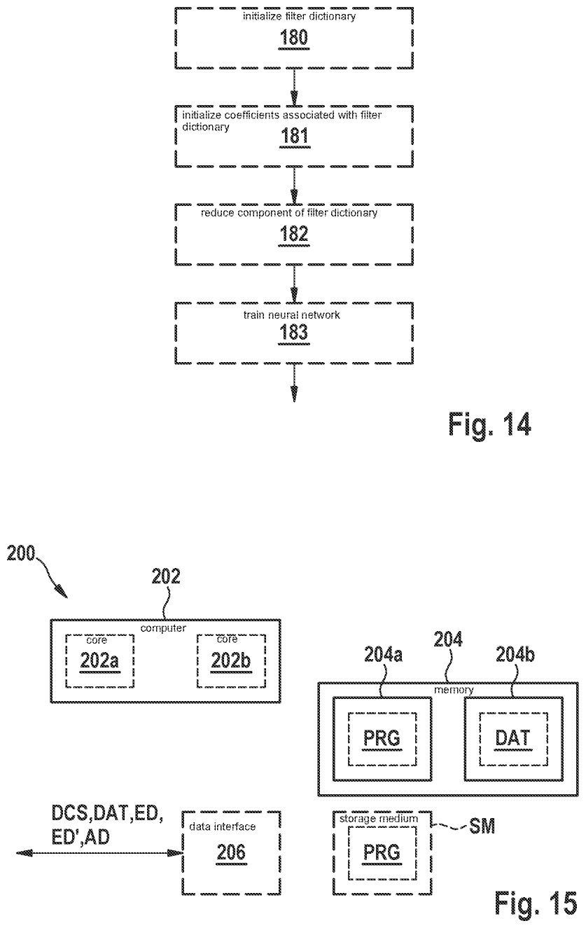

In further exemplary embodiments, FIG. 14, it is provided that the method comprises at least one of the following elements: a) initializing 180 the at least one filter dictionary FD, b) initializing 181 coefficients associated with the at least one filter dictionary FD, c) reducing 182, for example thinning out, for example pruning, at least one component of the at least one filter dictionary FD, for example according to the embodiments, d) training 183 the neural network NN, for example the at least one filter dictionary FD, for example together with at least one further component NN-K1 of the neural network NN, for example based on a gradient-based optimization method.

In further exemplary embodiments, the following sequence may be provided in order to provide a trained neural network NN′ comprising (e.g., trainable) filters that can be represented by means of the at least one filter dictionary FD:

1) optionally: initializing k filter dictionaries [symbol] ₀⁽¹⁾, . . . , [symbol] ₀⁽¹⁾ (for example according to FIG. 3) that optionally respectively characterize a linear space, for example, wherein the space can also be referred to as “interspace” in further exemplary embodiments,
1a) optionally: sharing at least some of the filter dictionaries [symbol] ₀⁽¹⁾, . . . , [symbol] ₀⁽¹⁾ initialized according to step 1), i.e., using, for example, the at least some of the filter dictionaries [symbol] ₀⁽¹⁾, . . . , [symbol] ₀⁽¹⁾ initialized according to step 1), for example for other layers of the neural network NN,
2a) assigning a respective filter dictionary [symbol] ₀^{(J}^{ₗ}⁾ to at least one of L layers l∈{1, . . . , L} of the neural network NN, wherein J is, for example, an assignment function that assigns to an l-th layer the filter dictionary [symbol] ₀^{(J}^{ₗ}⁾. For example, a global sharing or using the same filter dictionary may be implemented with Jₗ=1∀l, i.e., the filter dictionary [symbol] ₀⁽¹⁾ is, for example, assigned to all l layers,
2b) initializing the coefficients λ₀^{(l)} for the L layers, for example according to FIG. 4,
3a) optionally: determining a, for example global, pruning mask p for the reducing, for example according to FIG. 5, wherein the determining of the pruning mask p may, for example, occur based on at least one conventional method, for example on SNIP, GraSP, SynFlow,
3b) optionally: reducing, for example pruning, the coefficients λ₀^{(l)} for the filter dictionaries, for example by means of the pruning mask p, for example according to λ₀⊙μ, wherein λ₀=(λ₀⁽¹⁾, . . . , λ₀^{(L)}) characterizes the (e.g., global) filter coefficients, and wherein ⊙ characterizes the Hadamard product or element-wise product. This operation may also be referred to as “interspace pruning” in further exemplary embodiments because the optional pruning can at least partially be applied to the interspace that can be characterized by the filter dictionaries or to the coefficients associated with the filter dictionaries.
4) For example, for T many training steps, t∈{1, . . . , T},
4a) performing a forward pass, for example based on the filter dictionaries [symbol] ₜ₋₁⁽¹⁾, . . . , [symbol] ₜ₋₁^{(k)} and based on the coefficients λₜ₋₁⊙μ (e.g., pruned or reduced by means of pruning mask μ), for example according to

$$h ★ X = {( {\sum }_{β = 1}^{{c}_{in}} {\sum }_{n = 1}^{N} {λ}_{n}^{( α , β )} \cdot ( {g}^{( n )} ★ {X}^{( β )} ) )}_{α} ,$$

4b) performing a backward pass, for example based on the filter dictionaries [symbol] ₜ₋₁⁽¹⁾, . . . , [symbol] ₜ₋₁^{(k)} and based on the coefficients λₜ₋₁⊙μ (e.g., pruned or reduced by means of pruning mask μ), for example according to

$$\frac{\partial ℒ}{\partial {λ}_{n}^{( α , β )}} = 〈 \frac{\partial ℒ}{\partial {Y}^{( α )}} \cdot {g}^{( u )} ★ {X}^{( β )} 〉 and \frac{\partial ℒ}{\partial {g}^{( n )}} = {\sum }_{α = 1}^{{c}_{out}} {\sum }_{β = 1}^{{c}_{in}} {λ}_{n}^{( α , β )} \cdot ( \frac{\partial ℒ}{\partial {Y}^{( α )}} ★ {X}^{( β )} ) ,$$

if a sharing of filter dictionaries occurs in the forward pass 4a), this may also be performed in the backward pass 4b) in further exemplary embodiments,
4c) applying a, for example stochastic, gradient-based optimization to the filter dictionaries [symbol] ₜ₋₁⁽¹⁾, . . . , [symbol] ₜ₋₁^{(k)} and the coefficients λₜ₋₁⊙μ based on the backward pass according to previous step 4b),
wherein, for example, after the T training steps 4a), 4b), 4c), trained filter dictionaries [symbol] _{T}⁽¹⁾, . . . , [symbol] _{T}^{(k)}, for example with sparsely populated coefficients λ_{T}⊙μ, are obtained, by means of which, for example, a trained neural network NN′ can be provided.

In further exemplary embodiments, the optional pruning 3a), 3b) may, for example, also be omitted or be performed during the training 4) or after the training 4).

In further exemplary embodiments, an infinite number of training steps t are also possible, which, for example, corresponds to continuous training.

In further exemplary embodiments, different pruning masks μ may also be used for at least two different training steps t1, t2.

In further exemplary embodiments, in addition to the aspects described above with reference to steps 4a), 4b) 4c), further parameters or hyperparameters of the neural network NN may also be trained, for example weights of fully connected layers NN-K1, etc.

Further exemplary embodiments, FIG. 15, relate to an apparatus 200 for performing the method according to the embodiments, for example for a processing 102 of input data ED by means of the, for example trained, neural network NN, and/or for a training 150, 160 and/or for a pruning 130.

In further exemplary embodiments, it is provided that the apparatus 200 comprises: a computing device (“computer”) 202 comprising, for example, one or more, in the present case, for example, two, computing cores 202a, 202b; a memory device 204 assigned to the computing device 202 for at least temporarily storing at least one of the following elements: a) data DAT (e.g., input data ED and/or training data TD and/or data for an operation of the neural network NN (e.g., weights and/or filter coefficients, data of the at least one filter dictionary FD), b) computer program PRG, in particular for performing a method according to the embodiments.

In further exemplary embodiments, the memory device 204 comprises a volatile memory 204a (e.g., random access memory (RAM)) and/or a non-volatile memory 204b (e.g., flash EEPROM).

In further exemplary embodiments, the computing device 202 comprises at least one of the following elements or is designed as at least one of these elements: microprocessor (μP), microcontroller (μC), application-specific integrated circuit (ASIC), system on chip (SoC), programmable logic module (e.g., FPGA, field programmable gate array), hardware circuitry, graphics processor, tensor processor, or any combinations thereof.

Further exemplary embodiments relate to a computer-readable storage medium SM comprising instructions PRG that, when executed by a computer 202, cause the latter to perform the method according to the embodiments.

Further exemplary embodiments relate to a computer program PRG comprising instructions that, when the program is executed by a computer 202, cause the latter to perform the method according to the embodiments.

Further exemplary embodiments relate to a data carrier signal DCS that characterizes and/or transmits the computer program PRG according to the embodiments. For example, the data carrier signal DCS can be received via an optional data interface 206 of the apparatus 200, via which, for example, at least some of the following data can also be exchanged (sent and/or received): DAT, ED, ED′, AD.

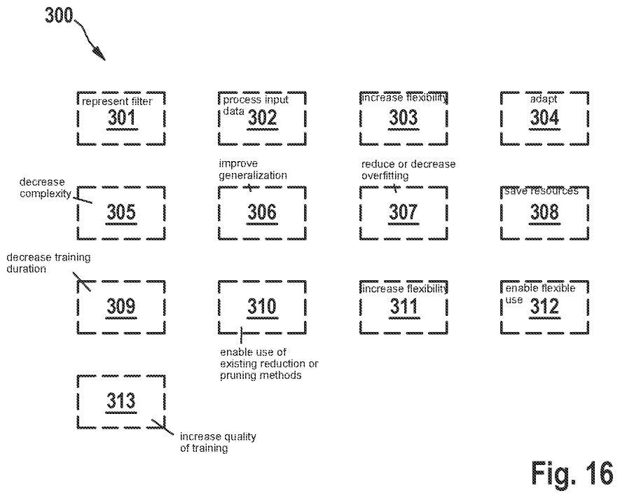

Further exemplary embodiments, FIG. 16, relate to a use of the method according to the embodiments and/or of the apparatus 200 according to the embodiments and/or of the computer-readable storage medium SM according to the embodiments and/or of the computer program PRG according to the embodiments and/or of the data carrier signal DCS according to the embodiments for at least one of the following elements: a) representing 301 at least one filter FILT-1 of the neural network NN based on the at least one filter dictionary FD, b) processing 302 input data ED, and/or data ED′, ED″, AD that can be derived or are derived from input data ED, by using the at least one filter FILT-1, c) increasing 303 flexibility with regard to the representation of the at least one filter FILT-1, d) adapting 304 dynamically, i.e., adapting can be performed, for example, during a performance of the method according to embodiments, the at least one filter FILT-1, for example during a training 150, 160 in which at least one further component NN-K1 of the neural network NN is also trained, e) decreasing 305 a complexity of the neural network NN, for example by pruning components of the at least on filter dictionary or the coefficients associated therewith, f) improving 306 a generalization by the neural network NN, for example in the sense that a behavior of the neural network NN during a training becomes more similar to a behavior of the neural network outside of the training, for example when evaluating input data ED other than training data TD, g) reducing 307 or decreasing an overfitting, for example “memorizing” the training data TD, h) saving 308 storage resources 204 and/or computing time resources required for a representation and/or an evaluation of the neural network NN, i) decreasing 309 a training duration, j) enabling 310 use of existing reduction methods or pruning methods for neural networks NN, for example structured and/or unstructured pruning methods, for example also for reducing at least one component of the at least one filter dictionary FD, k) increasing 311 flexibility with regard to initializing the at least one filter dictionary FD, l) enabling 312 flexible use of the at least one filter dictionary FD, for example selectively, for at least one component, for example a layer L1, L2, of the neural network NN, for example a flexible sharing of the at least one filter dictionary FD between different components L1, L2 of the neural network NN, m) increasing 313 a quality of a training 150, 160 and/or an evaluation, for example inference, of the neural network NN.

Further exemplary embodiments provide an adaptivity of the at least one filter dictionary so that the neural network can, for example, be better represented with comparatively few parameters than in a conventional spatial representation of the filter coefficients.

1-25. (canceled)

26. A computer-implemented method, for processing data associated with an artificial deep neural network, comprising:
representing at least one filter of the neural network based on at least one filter dictionary; and,
processing input data and/or data derived from input data, using the at least one filter.

27. The method as recited in claim 26, wherein the artificial deep neural network is a convolutional neural network.

28. The method as recited in claim 26, wherein the at least one filter dictionary at least partially characterizes a linear space, wherein, the at least one filter dictionary is characterized by [symbol] :={g⁽¹⁾, . . . , g^{(N)}}⊂ [symbol] ^{K1×K2}, wherein characterizes an i-th filter of the at least one filter dictionary, where i=1, . . . , N, wherein K1 characterizes a size of the filters of the at least one filter dictionary in a first dimension, wherein K2 characterizes a size of the filters of the at least one filter dictionary in a second dimension, wherein span{ [symbol] } characterizes the linear space that the at least one filter dictionary at least partially characterizes.

29. The method as recited in claim 26, wherein a) the at least one filter dictionary does not completely span a space orb) at least some elements of the at least one filter dictionary are linearly dependent on one another and the at least one filter dictionary is overcomplete.

30. The method as recited in claim 26, wherein the at least one filter dictionary is different from a standard basis [symbol] , according to [symbol] :={e⁽ⁿ⁾: n=1, . . . , K²}, wherein e⁽ⁿ⁾ characterizes an n-th unit vector associated with the standard basis [symbol] .

31. The method as recited in claim 26, wherein the representing of the at least one filter of the neural network based on the at least one filter dictionary is characterized by the following equation and/or is performed based on the following equation: h=Σₙ₌₁^{N}λₙ·g⁽ⁿ⁾, wherein h characterizes the at least one filter, wherein g⁽ⁿ⁾ characterizes an n-th filter of the at least one filter dictionary, wherein λₙ characterizes a coefficient associated with the n-th filter of the at least one filter dictionary, and wherein n is an index variable that characterizes one of N filters of the at least one filter dictionary, wherein representing of a plurality of filters h^{(α,β)}, associated with a layer of the neural network, based on the at least one filter dictionary, is characterized by the following equation and/or is performed based on the following equation: h^{(α,β)}=Σₙ₌₁^{N}λₙ^{(α,β)}·g⁽ⁿ⁾, wherein α characterizes an index variable associated with a number of output channels of the layer, wherein β characterizes an index variable associated with a number of input channels of the layer, wherein λₙ^{(α,β)} characterizes a coefficient, associated with the n-th filter of the at least one filter dictionary, for the output channel and the input channel β of the layer.

32. The method as recited in claim 26, wherein the processing of the input data and/or the data derived from the input data by using the at least one filter is characterized by the following equation and/or is performed based on the following equation:
$$h ★ X = {( {\sum }_{β = 1}^{{c}_{in}} {\sum }_{n = 1}^{N} {λ}_{n}^{( α , β )} \cdot ( {g}^{( n )} ★ {X}^{( β )} ) )}_{α} ,$$
wherein X characterizes the input data or the data derived from the input data, including an input feature map for a layer of the neural network, wherein α characterizes an index variable associated with a number of output channels of the layer, wherein β characterizes an index variable associated with a number of input channels of the layer, wherein λₙ^{(α,β)} characterizes a coefficient, associated with the n-th filter of the at least one filter dictionary, for the output channel α and the input channel β of the layer, wherein cm characterizes a number of the input channels of the layer, and wherein * characterizes a convolution operation.

33. The method as recited in claim 26, further comprising:
initializing the at least one filter dictionary prior to the representing and/or the processing;
wherein the initializing includes at least one of the following elements:
a) random-based initializing by assigning random numbers or pseudorandom numbers to at least some filter coefficients g_{i,j}⁽ⁿ⁾ of at least some filters of the at least one filter dictionary,
b) random-based initializing such that a linear space span{ [symbol] } that is characterized by the at least one filter dictionary is spanned by an orthonormal basis, including:
b1) initializing at least some filter coefficients g_{i,j}⁽ⁿ⁾ of at least some filters of the at least one filter dictionary with independently equally distributed filter coefficient values,
b2) applying a Gram-Schmidt orthogonalization method to the elements or filters of the at least one filter dictionary,
c) random-based initializing by:
c1) initializing at least some filter coefficients g_{i,j}⁽ⁿ⁾ of at least some filters of the at least one filter dictionary with independently equally distributed filter coefficient values,
c2) rescaling the at least one filter dictionary based on at least one statistical quantity, for example a mean and/or a standard deviation.

34. The method as recited in claim 26, further comprising:
initializing coefficients of at least some filters of the at least one filter dictionary, including at least one of the following:
a) random-based or pseudorandom-based initializing of the coefficients,
b) initializing the coefficients based on the at least one filter dictionary.

35. The method as recited in claim 26, further comprising:
reducing at least one component of the at least one filter dictionary, wherein the reducing includes at least one of the following:
a) reducing at least one filter of the at least one filter dictionary by zeroing at least one filter coefficient of the at least one filter of the at least one filter dictionary;
b) removing or deleting at least one filter of the at least one filter dictionary,
c) removing or deleting at least one coefficient associated with the at least one filter dictionary.

36. The method as recited in claim 35, further comprising at least one of the following:
a) performing the reducing after an initializing of the at least one filter dictionary,
b) performing the reducing after an initializing of coefficients of at least some filters of the at least one filter dictionary,
c) performing the reducing during a training of the neural network,
d) performing the reducing after the training of the neural network.

37. The method as recited in claim 26, further comprising at least one of the following:
a) using the at least one filter dictionary for a plurality of layers of the neural network,
b) using the at least one filter dictionary for a plurality of layers of the neural network that are associated with a same spatial size of data to be processed,
c) using the at least one filter dictionary for a respective residual block, the neural network being a residual neural network,
d) using the at least one filter dictionary for a layer of the neural network.

38. The method as recited in claim 26, further comprising:
training the neural network based on training data, wherein a trained neural network is obtained; and
using the trained neural network for the processing of the input data.

38. A computer-implemented method for training an artificial deep neural network, wherein at least one filter of the neural network is represented based on at least one filter dictionary, the method comprising:
training at least one component of the at least one filter dictionary, wherein the training of the at least one component of the at least one filter dictionary is performed at least temporarily simultaneously and/or together with a training of at least one other component of the neural network.

39. The method as recited in claim 38, further comprising:
providing a filter dictionary characterizing a standard basis, wherein the standard basis is characterized according to [symbol] :={e⁽ⁿ⁾: n=1, . . . , K²}, wherein e⁽ⁿ⁾ characterizes an n-th unit vector associated with the standard basis [symbol] ; and
changing the filter dictionary, characterizing the standard basis, based on the training.

40. The method as recited in claim 38, further comprising:
providing a filter dictionary not characterizing a standard basis; and
changing the filter dictionary not characterizing a standard basis, based on the training.

41. The method as recited in claim 38, further comprising:
providing a pre-trained neural network or performing a first training for the neural network;
performing a reducing on the pre-trained neural network; and
performing a further training.

42. The method as recited in claim 38, wherein the training includes:
training the at least one filter dictionary together with at least one coefficient associated with the at least one filter dictionary.

43. The method as recited in claim 26, wherein the processing of the input data includes at least one of the followings:
a) processing one- and/or multi-dimensional data,
b) processing image data,
c) processing audio data, the audio data including voice data and/or operating noises from technical equipment or systems,
d) processing video data or parts of video data,
e) processing sensor data; and
wherein the processing of the input data includes a classification of the input data.

44. The method as recited in claim 43, further comprising:
using output data obtained based on the processing of the input data to control and/or regulate at least one component of a technical system.

45. The method as recited in claim 26, further comprising at least one of the following elements:
a) initializing the at least one filter dictionary,
b) initializing coefficients associated with the at least one filter dictionary,
c) reducing at least one component of the at least one filter dictionary,
d) training the at least one filter dictionary together with at least one further component of the neural network based on a stochastic, gradient-based optimization method.

46. An apparatus configured to process data associated with an artificial deep neural network, the apparatus configured to:
represent at least one filter of the neural network based on at least one filter dictionary; and,
process input data and/or data derived from input data, using the at least one filter.

47. A non-transitory computer-readable storage medium on which are stored instructions for processing data associated with an artificial deep neural network, the instructions, when executed by a computer, causing the computer to perform the following steps:
representing at least one filter of the neural network based on at least one filter dictionary; and,
processing input data and/or data derived from input data, using the at least one filter.
